(19) United States
(12) Patent Application Publication
(10) Pub. No.: US 2020/0108468 A1
(43) Pub. Date: Apr. 9, 2020

(54) HYBRID ULTRASONIC AND RESISTANCE SPOT WELDING SYSTEM

(71) Applicant: Edison Welding Institute, Inc., Columbus, OH (US)

(72) Inventors: Mitchell P. Matheny, Hilliard, OH (US); Tim Frech, Columbus, OH (US); Matthew A. Short, Wilmington, OH (US); Jerry Gould, Grandview Heights, OH (US); David Workman, Dublin, OH (US); Lindsey Lindamood, Grandview Heights, OH (US)

(21) Appl. No.: 16/594,904

(22) Filed: Oct. 7, 2019

Related U.S. Application Data
(60) Provisional application No. 62/742,574, filed on Oct. 8, 2018.

(51) Int. Cl. B23K 28/02; B23K 20/10; B23K 11/11

(52) U.S. Cl. CPC B23K 28/02; B23K 2103/05; B23K 11/11; B23K 20/106

(57) ABSTRACT

A hybrid welding system, comprising a first welding system, wherein the first welding system includes an ultrasonic spot-welding system, and wherein the ultrasonic spot-welding system further includes at least one sonotrode for delivering ultrasonic vibration to a predetermined weld location; and a second welding system, wherein the second welding system includes a resistance spot welding system that functions simultaneously with the ultrasonic spot-welding system, and wherein the resistance spot welding system further includes at least one electrode that is configured to direct electrical current into the predetermined weld location.

### CROSS-REFERENCE TO RELATED APPLICATIONS

This patent application claims the benefit of U.S. Provisional Patent Application Ser. No. 62/742,574 filed on Oct. 8, 2018 and entitled “Hybrid Ultrasonic/Resistance Spot Welding System,” the disclosure of which is hereby incorporated by reference herein in its entirety and made part of the present U.S. utility patent application for all purposes.

### BACKGROUND

The described invention relates in general to welding systems, devices, and methods, and more specifically to systems, devices, and method that combine the functionality of ultrasonic spot-welding technology and resistance spot welding technology.

Aluminum and steel are primary materials used to create and manufacture components and parts used in the automotive and aerospace industries. To join certain alloys or high-strength materials to one another, rivets are often used when adequate welds cannot be achieved. This approach is not ideal because rivets provide opportunities for cracks to form in the joined materials. In some cases, welding of these materials can be accomplished, but at the expense of tool damage or accelerated tool wear. Additionally, the material being welded may experience changes in microstructural properties that reduce the strength of the base material at the heat-affected zone (HAZ), thereby creating a weak joint or a joint that is prone to cracking and failure. American automotive manufacturers are focused on integrating more light-weight materials into vehicles to reduce weight and improve fuel efficiency. Reducing vehicle weight for fuel efficiency is needed to meet Corporate Average Fuel Economy (CAFE) standards while still achieving the level of performance desired by consumers. Accordingly, materials used for structural applications should exhibit both low density and high strength. Aluminum is attractive because it has a high strength to weight ratio, has an acceptable cost, and can be used in critical automotive components. While aluminum can provide the structural strength necessary, creating a joint to withstand these demands at typical steel spot welding costs is challenging. Resistance spot welding and ultrasonic welding are two of the primary methods used to join aluminum or steel; however, welding high-strength aluminum alloys requires further development. Used individually, ultrasonic welding and resistance welding technologies face unique problems when welding aluminum (and when welding aluminum to other metals) and they also have advantages over one another in materials joining. However, by identifying and utilizing the positive aspects of each technology, an effective hybrid welding method can be created. Accordingly, there is an ongoing need for a hybrid ultrasonic-resistance welder that improves the weld strength of welded aluminum sheet materials and other metals.

### SUMMARY

The following provides a summary of certain examples. This summary is not an extensive overview and is not intended to identify key or critical aspects or elements of the disclosed systems, devices, and methods or to delineate their scope. It is to be understood that any respective features/examples of each of the aspects of the disclosure as described herein may be implemented together in any combination to achieve the results as described herein, and that any features/examples from any one or more of these aspects may be implemented together with any of the features of the other aspect(s) as described herein in any combination to achieve the benefits as described herein.

In one implementation, a first hybrid welding system is provided. This system comprises a first welding system, wherein the first welding system includes an ultrasonic spot-welding system, and wherein the ultrasonic spot-welding system further includes at least one sonotrode for delivering ultrasonic vibration to a predetermined weld location; and a second welding system, wherein the second welding system includes a resistance spot welding system that functions simultaneously with the ultrasonic spot-welding system, and wherein the resistance spot welding system further includes at least one electrode that is configured to direct electrical current into the predetermined weld location.

In another implementation, a second hybrid welding system is provided. This system comprises a first material; a second material to be spot welded to the first material at a predetermined location; an ultrasonic spot-welding system, wherein the ultrasonic spot-welding system further comprises at least one sonotrode having a rounded tip for delivering ultrasonic vibration to a predetermined weld location; and a resistance spot welding system that functions simultaneously with the ultrasonic spot-welding system, wherein the resistance spot welding system further includes at least one electrode that is configured to pass electrical current through the predetermined weld location.

In still another implementation, a third hybrid welding system is provided. This system comprises a first material; a second material to be spot welded to the first material at a predetermined location; an ultrasonic spot-welding system, wherein the ultrasonic spot-welding system further comprises at least one sonotrode having a rounded tip for delivering ultrasonic vibration to the predetermined location and at least one transducer connected to the at least one sonotrode; and a resistance spot welding system, wherein the resistance spot welding system is operative to function simultaneously with the ultrasonic spot-welding system, and wherein the resistance spot welding system further includes at least one electrode that is configured to pass electrical current through the predetermined location, wherein the electrical current is 10 kA or less.

Additional features and aspects of the present invention will become apparent to those of ordinary skill in the art upon reading and understanding the following detailed description of the exemplary implementations. As will be appreciated by the skilled artisan, further implementations of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more example implementations and, together with the general description given above and detailed description given below, explain the principles of the disclosed system, devices, and methods, and wherein:

FIG. 1 depicts an example implementation of a single wedge reed ultrasonic system imparting force and vibration to a workpiece;

FIG. 2 is a diagram demonstrating the removal of asperities between metal sheets using ultrasonic welding, wherein the arrows direct the progression of bonding with typical weld times between 0.25-s and 1.00-s;

FIG. 3 depicts an example hybrid welding system, wherein ultrasonic motion perpendicular to the orientation of the coupons is displayed;

FIG. 4 depicts an example combination of resistance electrodes with an ultrasonic welder;

FIG. 5 is a photograph showing measurement locations for weld collapse using spherical tips at t₁ and t₂;

FIG. 6 depicts pull test results for a 10 kA, 2250 W weld, wherein the full button pulled was 6.8 mm;

FIG. 7 depicts pull test result for a 0 kA, 2250 W weld, wherein the interfacial failure included a spot size of 5.4 mm;

FIG. 8 is a table summarizing peak loads at failure for varying applied current and ultrasonic power;

FIG. 9 depicts the surface of aluminum after welding with a serrated tip;

FIG. 10 depicts an interfacial failure of a weld made with a serrated tip at 10 kA applied current and 2000 W ultrasonic power;

FIG. 11 provides thermal imaging of a hybrid weld, wherein the temperature scale has not been calibrated, and wherein glowing at the center sonotrode shows heat concentration while glowing around the resistive heating clamps is simply reflection from the sonotrode;

FIG. 12 is an SEM image of solid-state extrusion of faying surface contaminants at a weld terminus;

FIG. 13 is an SEM image of Trial 330-15—0 kA, 2,250 W, scale bar at 200 μm;

FIG. 14 is an SEM image of Trial 330-15—0 kA, 2,250 W, scale bar at 50 μm;

FIG. 15 is an SEM image of Trial 330-21—10 kA, 2,250 W, scale bar at 200 μm;

FIG. 16 is an SEM image of Trial 330-21—10 kA, 2,250 W, scale bar at 50 μm;

FIG. 17 is an SEM image of the edge of the weld, Trial 330-21, 10 kA, 2250 W, wherein scrubbing motion is along the bond line shown, scale bar at 200 μm;

FIG. 18 is an SEM image of Trial 330-15—0 kA, 2,250 W; scale bar at 100 μm;

FIG. 19 is an SEM image of Trial 330-15—0 kA, 2,250 W; scale bar at 10 μm;

FIG. 20 is an SEM image of Trial 330-21—10 kA, 2,250 W; scale bar at 100 μm; and

FIG. 21 is an SEM image of Trial 330-21—10 kA, 2,250 W; scale bar at 10 μm.

### DESCRIPTION OF THE INVENTION

Example implementations of the disclosed systems, devices, and methods are now described with reference to the Figures. Although the following detailed description contains many specifics for purposes of illustration, a person of ordinary skill in the art will appreciate that many variations and alterations to the following details are within the scope of the disclosed system, devices, and methods. Accordingly, the following examples are set forth without any loss of generality to, and without imposing limitations upon, the disclosed system, devices, and methods.

The process of resistance spot welding produces a fusion type weld joint using the contact and bulk resistance of a material being welded to facilitate heating. Electrodes are used to apply force against outer sheets to be welded, conduct current into the joint, and to extract excess heat from the joint. Loads greater than 1000 N are frequently applied to the weld electrodes for creating a significant squeeze force at the stack of material to be joined. Welding current is applied to the stack through the electrodes to facilitate localized, interfacial melting. The amplitude of this current is dependent on the material being welded, its thickness, and its geometry. Welding occurs as the bulk resistance of the material is combined with the interfacial resistance between sheets, directing melting at the sheet interfaces. When melting has been achieved, the input of electrical current is terminated, and residual heat is absorbed by the electrodes, thereby promoting solidification in the welded joint.

Resistance spot welding is commonly used for assembling steel components used for automotive applications. However, aluminum requires extremely high welding currents due to its inherent thermal and electrical conductivity properties. Spot welds created in aluminum can display large heat affected zones and solidification defects if precise process control is not maintained. Additionally, results achieved using resistance spot welding with aluminum can be inconsistent due to aggressive electrode wear. Resistance welding can be used to effectively weld aluminum in automotive facilities, but at the expense of tool life and process consistency. Accordingly, much research has focused on controlling the contact resistance of aluminum in order to minimize electrode wear. Currently, intensive tip dressing schedules are used to address this challenge. The automotive industry typically uses mid-frequency direct current (MFDC) welding power, and while no significant detriment can be attributed to the power type in the welding of steel, when welding aluminum, the Peltier Effect present in direct current (DC) current causes preferential heating and corresponding electrode wear. This effect increases the wear rate on the electrodes such that electrode changing or dressing requirements become significant and problematics. Accordingly, accomplishing full shift production on a single set of electrodes can be challenging. Frequent dressing does extend electrode life, but an increased level of dressing is challenging to employ for standard automotive applications.

The aerospace industry has traditionally utilized resistance spot welding for the assembly of aircraft parts (e.g., the use of Mil-S-6858). Aerospace companies control the contacting of the free surface of aluminum sheet by utilizing intensive surface cleaning procedures and controls to achieve consistent surface conditions. A cleanly etched aluminum surface requires additional current because contact resistance has been reduced. Heavy frame “Mil-Spec welders” or primary rectified systems used in aerospace are too large and heavy for automation and use in the automotive industry. Additionally, welding currents required to weld oxide free aluminum are very high and require elevated primary current draws. These process features work well in a low to moderate volume aerospace manufacturing environment; however, for automotive applications, these processes add undesirable cost and additional steps to the production cycle. Resistance spot welds created in automotive aluminum may display gas pores due to coatings and hydrogen pick-up from contamination in the oxide coating. The control of the gas porosity is important for consistently achieving desired mechanical properties from a resistance spot weld. Any loss of cross section area may result in a reduction in strength. Porosity also can become detrimental when it occurs in a chain of linear small diameter defects. This is often described as “connecting the dots”. To avoid any risk of gas porosity, a solid-state weld is most desirable because no melting occurs, thereby eliminating the creation of gas pores.

Ultrasonic metal welding is a solid-state joining process that utilizes relative motion between two contacting surfaces held under pressure to create a bond. Bonding is achieved when native oxide and other contamination is broken up and redistributed as two sheets of material are “scrubbed” together. This scrubbing action occurs at ultrasonic frequencies, typically between 2060 kHz, with amplitudes on the order of 25-150 μm. The result is a metallurgically clean, flat surface that permits the sharing of electrons between atoms. As the welding action continues, these bonds are repeatedly broken and formed until the action stops. The resulting weld size and strength is dependent on the pressure and amplitude applied, as well as the ability of sonotrodes used in the process to grip the material and not simply slip on the surfaces. When a final joint is etched and inspected under microscopy, the bond line will appear to be disconnected. This is due to the etchant attacking the higher energy grain boundaries and does not indicate a poor joint. A better understanding of joint quality can be interpreted from the geometry of the bond line; if the weld did not fully set down, the bond line will appear to be wavy rather than flat.

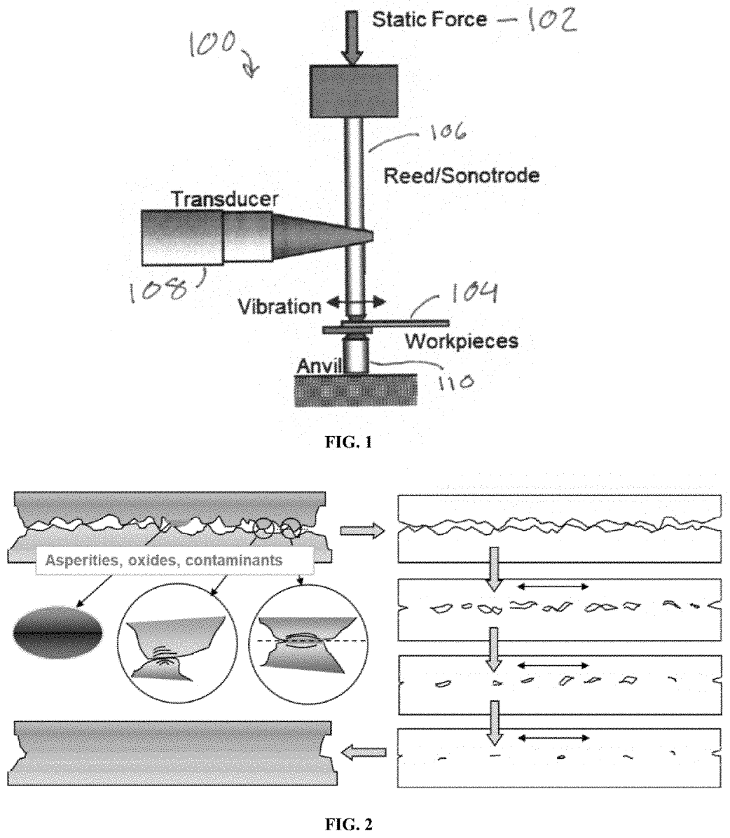

Recent research has involved systems that deliver a range of vibrational frequencies to resistance welding electrodes during the application of current for promoting the disruption of oxides between thick aluminum sheets. Initial experiments demonstrated that applying low frequency vibrations to electrodes, without passing current, produced a cold weld at the workpiece. Commercialization of welders using transversely applied ultrasonic vibrations to the workpiece occurred shortly thereafter. Currently, high power ultrasonic welding is often used to join relatively thin sheets of similar or dissimilar materials. FIG. 1 provides an image of a single wedge reed style ultrasonic welder 100. Metal welding occurs when sufficient amplitude and force 102 are delivered into material stack 104. Transducer 108 provides ultrasonic energy to reed/sonotrode 106, which is directed into stack 104, underneath which anvil 110 is positioned.

FIG. 2 provides a simplified diagram of welding progression at the interface of two sheets of material. Asperities between metal sheets are removed using ultrasonic welding, wherein the arrows direct the progression of bonding with typical weld times between 0.25-s and 1.00-s. Power is generated by an ultrasonic transducer oscillating at frequencies between 20 and 60 kHz. The amplitude achieved at the work piece by the sonotrode can be between 20 and 150 μm. At sufficient forces and amplitudes for a given material stack-up, this scrubbing motion promotes a metallurgically clean, flat surface at each interface, therefore allowing electron sharing between atoms of adjacent sheets. The resulting weld interface is distinguishable by etching the metals, which preferentially attacks the high energy grain boundaries. Thus, spot welding aluminum sheet can be done using ultrasonic welding; however, as material thickness or hardness increases, the power required from a given welder for creating an acceptable joint is eventually surpassed. Also, material transfer of aluminum onto the tips of the sonotrode is difficult to avoid, even with optimized knurling provided at the sonotrode tip. Often, a serrated style sonotrode tip is used to weld aluminum. The grooves on the sonotrode face facilitate material transfer and require frequent and aggressive cleaning procedures.

As previously discussed, aluminum sheet metal is a highly important material for automotive construction. However, a major challenge in using aluminum for automotive applications involves difficulties associated with creating reliable joints that meet all production expectations and requirements. Both resistance spot welding (RSW); and (ii) ultrasonic spot welding (USW) have been investigated for use in automotive applications. The use of resistance spot welding carried out with medium frequency direct current (MFDC) power supplies is challenged by high current demands, solidification features, and differential electrode wear. The use of ultrasonic spot-welding is challenged by low productivity and limited thickness of overall stack-up. Accordingly, the present invention provides a hybrid process that uses both direct current and ultrasonic power for welding aluminum and other metals. Welds created with the disclosed systems and methods demonstrate higher strength when mechanically pull-tested compared to welds made with ultrasonic welding processes alone. As discussed below, example implementations successfully joined A1 6061 to itself. Results obtained using the disclosed hybrid system indicate that resistance heating effectively provides initial softening of the material (at low currents compared to spot welding), thereby allowing the ultrasonic system to achieve necessary deformations at energy levels consistent with currently available systems. This hybrid process facilitates nominally ultrasonic type spot welds, but with higher productivity and thickness ranges of sheets that can be successfully joined. Also disclosed are example implementations of sonotrodes having a rounded tip geometry that more closely resembles a resistance spot welding electrode, thereby improving weld strength and reducing surface deformation on welded materials.

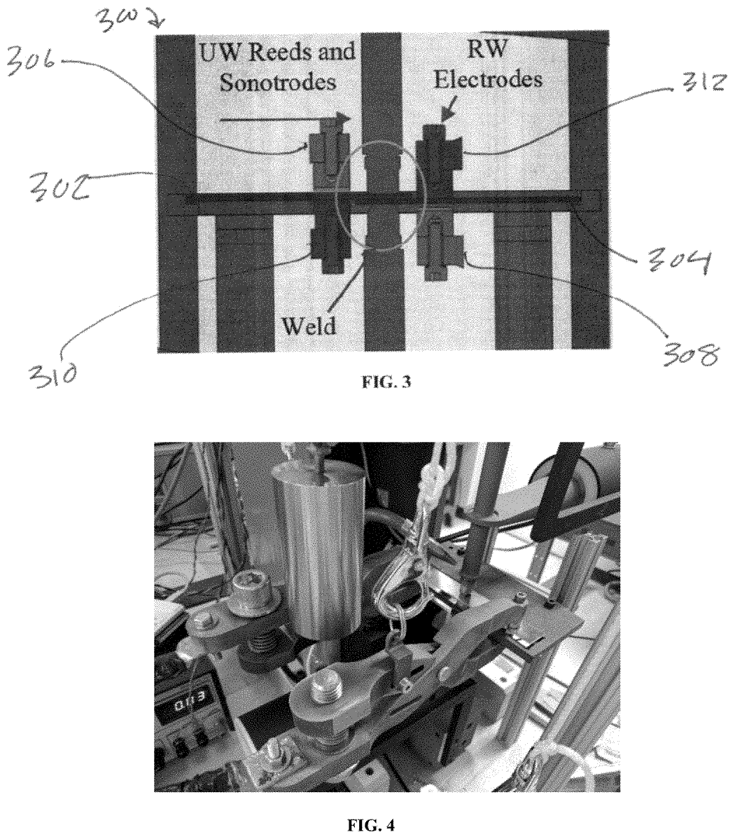

Aluminum 6061 was used to demonstrate the effectiveness of the systems and methods of the present invention because it has been well characterized, is readily available, and welding parameters and metallurgical outcomes have been established and are known to those skilled in the art. Applying a novel weld process to this material allows the effectiveness of the disclosed systems and methods to be more easily and clearly demonstrated. All experimental work was done using 1-mm thick aluminum 6061 sheared into 25×100 mm coupons. Each coupon was deburred and cleaned with methanol. Ultrasonic motion and clamping force were applied using a WS2026DWR/FC2036 dual-wedge reed metal welder from Sonobond (see the assemblies shown in FIGS. 3-4). FIG. 3 depicts an exemplary implementation of hybrid welding system 300, wherein ultrasonic motion perpendicular to the orientation of coupons 302 and 304 is displayed. Ultrasonic welding reeds and sonotrodes 306 and 308 provide ultrasonic input and resistance welding electrodes 310 and 312 provide electrical input to system 300.

FIG. 4 is a photograph of an exemplary setup of resistance electrodes with an ultrasonic welder. 20 kHz transducers included on this unit drive vertical reeds in opposing, out-of-phase motion at the work piece. Clamping force is pneumatically controlled by lowering an upper sonotrode to a fixed lower sonotrode. Serrated tips and smooth, spherical tips were used on both sonotrodes for a comparative study. Between every weld, a cleaning cycle was performed to remove any transferred aluminum by placing copper between the sonotrodes and running a welding cycle. Transferred aluminum preferentially bonds to the copper and is therefore removed from the steel tips. This process was effective for maintaining welding consistency throughout experimentation. Resistance heating was applied using custom copper and steel clamps. The clamps were attached to each coupon approximately 32-mm from the sonotrodes with sufficient pressure to prevent material expulsion at their point of contact during welding. Power to the clamps was supplied by an IS-120B Miyachi MFDC inverter attached to a 9-V MFDC transformer. Test coupons were positioned between the sonotrodes with a 25-mm overlap in a lap-shear configuration. Ultrasonic motion was applied perpendicular to the long direction of the stacked coupons.

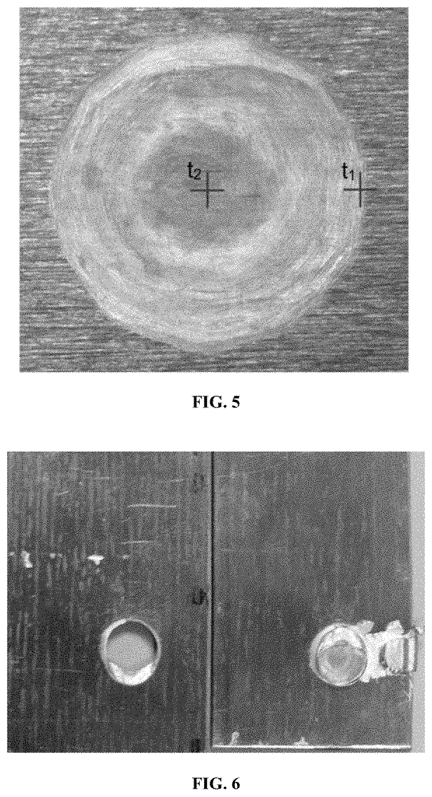

A weld monitoring system collected real-time current and voltage readings from the output of a dual wedge reed (DWR) power supply. Data was recorded through a custom graphical user interface developed by EWI, Inc. (Columbus, Ohio) with ultrasonic and resistive voltage and current displayed. Heat distribution was monitored using a thermal imaging camera. Due to high reflectivity, recorded temperature values were arbitrary and used only for qualifiable purposes. With reference to FIG. 5, weld collapse was measured for all trials by calipers and measurement locations were the center of the weld (t₂) and the edge of the weld (t₁). TABLE 1 (below) provides the average collapse measurements for the summarized trials. Measured values increased as applied current increased; however, within the triplicate resistive heating group, the collapse was not linear with higher ultrasonic powers.

TABLE 1
Results for hybrid welding of aluminum 6061 using spherical tips.

| | | | Average | |
|---|---|---|---|---|
| Reference | | Ultrasonic | Collapse | Average Shear |
| Trial | Current (kA) | Power (W) | Δt (mm) | Strength (N) |
| 330-30 | 0 | 1750 | 0.076 | 2665 +/− 25 |
| 330-6 | 0 | 2000 | 0.085 | 2778 +/− 274 |
| 330-15 | 0 | 2250 | 0.076 | 2669 +/− 182 |
| 330-27 | 7 | 1750 | 0.102 | 3423 +/− 53 |
| 330-12 | 7 | 2000 | 0.11 | 2958 +/− 157 |
| 330-18 | 7 | 2250 | 0.1.06 | 3365 +/− 60 |
| 330-24 | 10 | 1750 | 0.152 | 3666 +/− 101 |
| 330-9 | 10 | 2000 | 0.157 | 3735 +/− 47 |
| 330-21 | 10 | 2250 | 0.178 | 3741 +/− 126 |

Welds were evaluated by mechanical pull testing to AWS D8.9M and weld metallurgy was examined using optical microscopy and scanning electron microscopy (SEM). Samples for evaluation were polished using standard techniques. Screening trials were first performed to select a weld pressure for the sonotrodes, and this pressure was then used throughout all experimental trials. Timing of the applied current against the ultrasonic start was then determined. Best defined practices included a simultaneous start time of the applied current and ultrasonic power and for all trials, current was applied for 50-ms and ultrasonic power was applied for 300-ms.

Changing the amperage of the applied current and the ultrasonic power used to weld, as well as comparing shear strength results when welding with serrated or spherical tips were aspects of this experimentation. TABLE 1 (above) sumnmarizes weld trial settings and results using spherical tips. This table includes the applied current and ultrasonic power with measured average collapse of the weld and the average shear strength from mechanical pull testing. The reference trial number used in the table corresponds to microscopy data collected from that weld setting family.

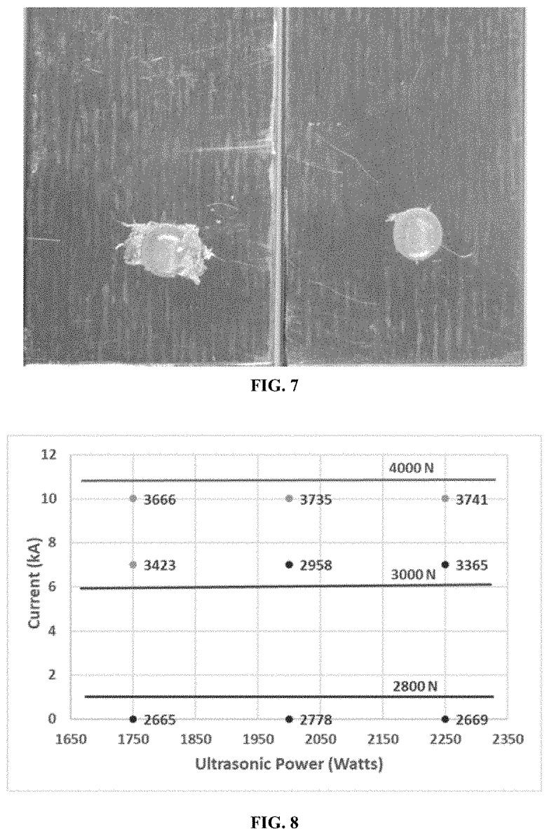

During mechanical testing, failures observed were interfacial failures for welds made with little or no resistive heating. Welds with higher applied currents failed in the base metal and weld buttons were pulled. Examples of these types of failures are shown in FIGS. 6-7. Spot diameter for welds that resulted in interfacial failure were typically more than a millimeter less than those pulling full buttons. FIG. 6 depicts pull test results for a 10 kA, 2250 W weld, wherein the full button pulled was 6.8 mm and FIG. 7 depicts pull test results for a 0 kA, 2250 W weld, wherein the interfacial failure included a spot size of 5.4 mm. The difference in failure modes shown in FIG. 6 and FIG. 7 correspond to resulting loads of 3400 N. These results are summarized in FIG. 8 wherein average weld strength is plotted against applied current and ultrasonic power. From this plot, the markers indicate if the failure was interfacial (dark dot) or base metal failure (light dot). The lines in FIG. 8 represent milestone marks in load strength.

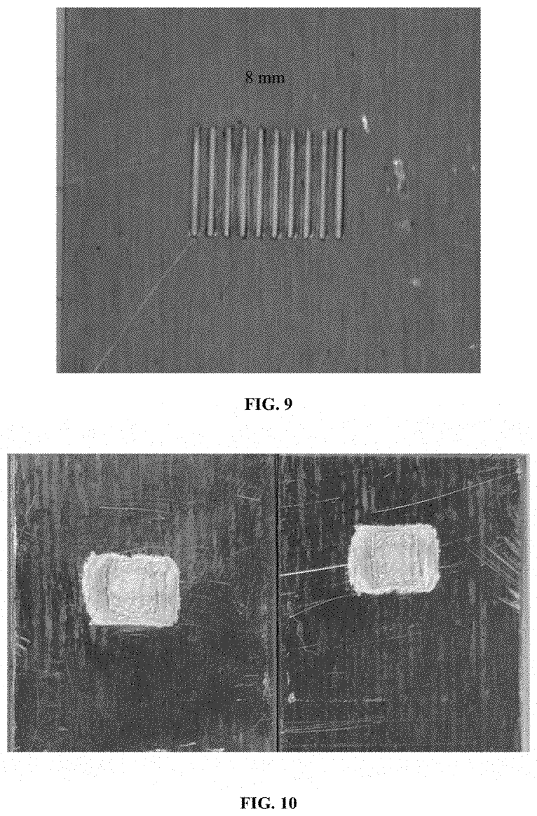

TABLE 2 (below) summarizes weld trial settings and results using serrated tips. TABLE 2 includes average strength values from mechanical pull testing. Unlike welds made with spherical tips, there is not a large range of shear strengths using the serrated tips between trials with applied current between zero and 10 kA. FIG. 9 depicts the surface of aluminum after welding with a serrated tip and FIG. 10 depicts an interfacial failure of a weld made with a serrated tip at 10 kA applied current and 2000 W ultrasonic power.

TABLE 2
Weld results for hybrid welding of aluminum 6061 using serrated tips.

| Reference | Current | Ultrasonic | Average Shear |
|---|---|---|---|
| Trial | (kA) | Power (W) | Strength (N) |
| 224-6 | 0 | 2000 | 3087 +/− 91 |
| 223-6 | 10 | 2000 | 3271 +/− 88 |

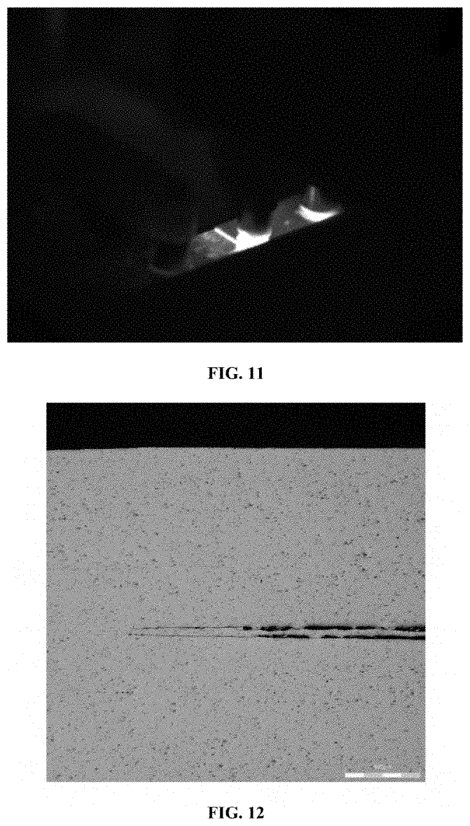

Thermal imaging revealed that heat loss can be observed if the clamping pressure of the resistive electrodes was inadequate and hot spots occurred. An example still image is shown in FIG. 11, wherein there are three contact points shown. The center contact is the sonotrode location, while the outer contact points are the resistance electrodes. The resistance electrode showing excessive heat is a reflection from the heat generated at the weld zone. This is inferred due to the lack of heating under the foreground electrode. Post inspection of the part also is indicative of heat distribution as there are no hot spots at the point of contact from the resistance electrodes.

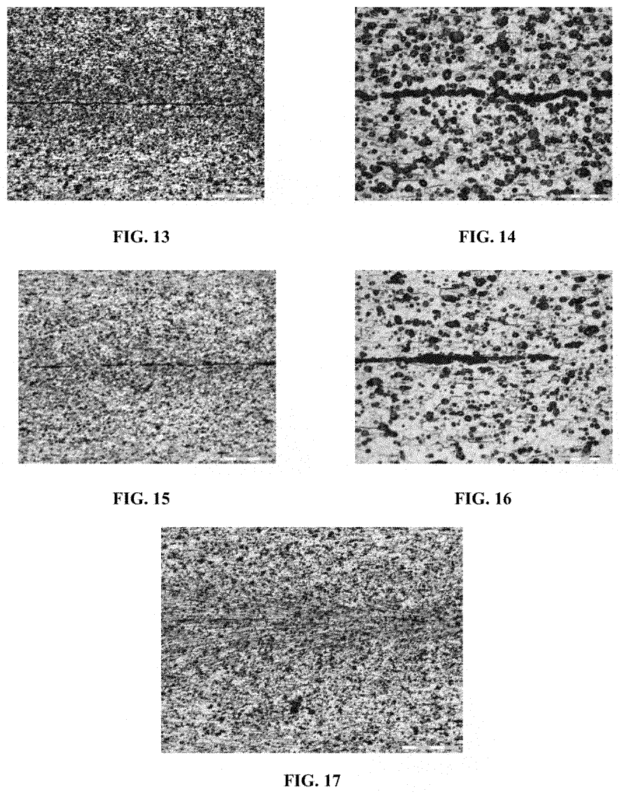

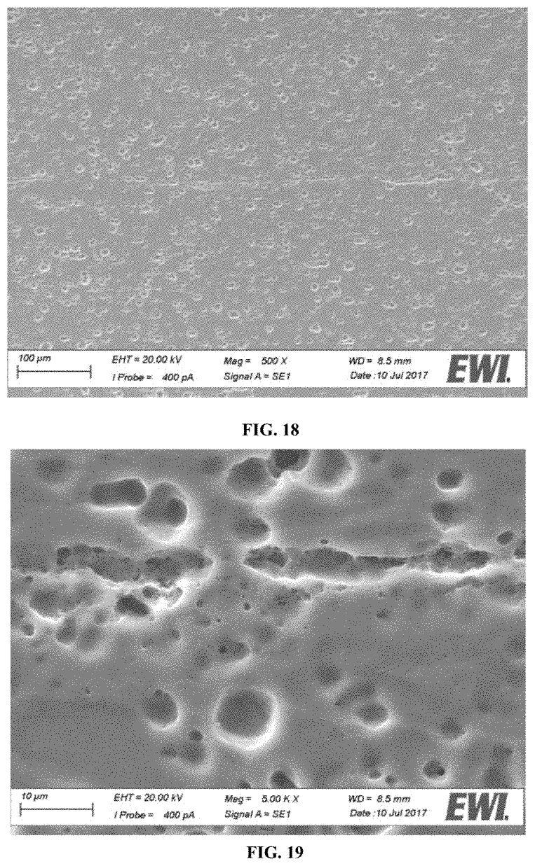

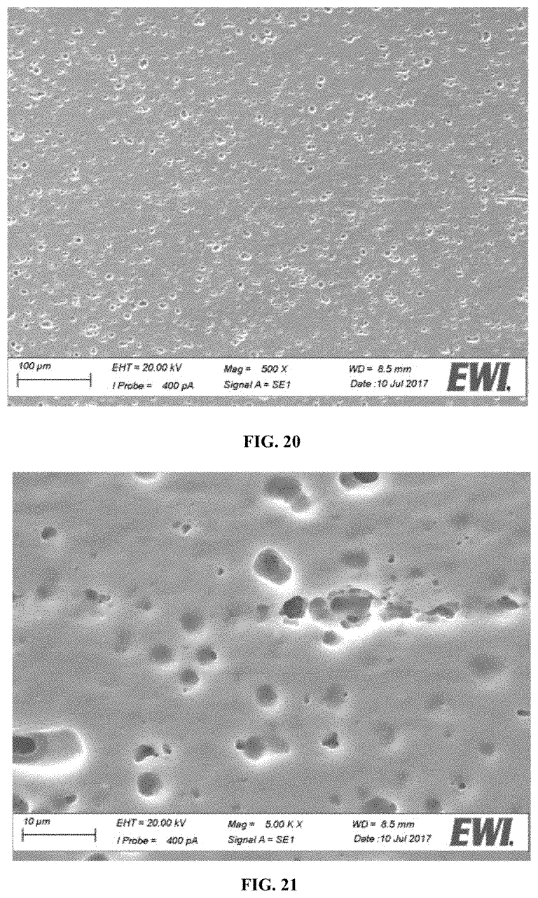

Metallographic experimental results demonstrated that the hybrid process of this invention maintains solid state welding morphology. Illustrative optical microscopy results are shown in FIGS. 13-16. FIG. 13 is an SEM image of Trial 330-15—0 kA, 2,250 W, scale bar at 200 μm; FIG. 14 is an SEM image of Trial 330-15—0 kA, 2,250 W, scale bar at 50 μm; FIG. 15 is an SEM image of Trial 330-21—10 kA, 2,250 W, scale bar at 200 μm; and FIG. 16 is an SEM image of Trial 330-21—10 kA, 2,250 W, scale bar at 50 μm. These images were collected from welding trials performed at an ultrasonic power of 2250 W and either no applied current, or 10 kA using the spherical tips. Both macro and micro images are presented. In these images there is no evidence of dendrites or porosity typically present in melt and re-solidified fusion processes. Additionally, material forged out of the faying surface appears as a solid stream rather than molten expulsion. (see FIG. 12). This is typical of ultrasonic spot welds. From these micrographs, as more aggressive weld parameters are applied, bond line etching response changes suggesting changes due to thermal and mechanical cycling. With high applied current and ultrasonic power, these features appear to be elongated especially nearest the bond line. The density of these features increases for applied current being on or off. However, the range of densified second phase particles and voids increase with applied current. Another indication of increased metallurgical activity with applied current is seen by flow line patterns. Flow lines are seen in the micrographs as annealed material traverses the bond line. This is especially apparent in FIG. 17. FIG. 17 is an SEM image of the edge of the weld, Trial 330-21, 10 kA, 2250 W, wherein scrubbing motion is along the bond line shown, scale bar at 200 μm. In this instance, the edge of the weld is at the right side of the image where the material would be experiencing the effects of primarily ultrasonic motion. The heat from the applied current causes the divergence out into the center of the weld on the left side of the image. The same samples are shown in FIGS. 18-21 with images collected by secondary electron emission through SEM. In these images, the bond line becomes less apparent with applied current. In only a few locations for trial 330-21 is the bond line obvious where remaining voids indicate the interface has not become completely homogeneous. FIG. 18 is an SEM image of Trial 330—15—0 kA, 2,250 W; scale bar at 100 μm; FIG. 19 is an SEM image of Trial 330-15—0 kA, 2,250 W; scale bar at 10 μm; FIG. 20 is an SEM image of Trial 330-21—10 kA, 2,250 W; scale bar at 100 μm; and FIG. 21 is an SEM image of Trial 330-21—10 kA, 2,250 W; scale bar at 10 μm.

The experimental data presented herein demonstrates that the hybrid welding process of this invention improves the weldability of aluminum. As previously described, resistive heating was applied to aluminum to locally reduce the yield strength of the material for a discrete period of time. This reduction in yield strength allowed the ultrasonic welder to more easily deform the material and reduced the power necessary to create a weld. Further, by reducing the necessary power, tool life is improved and material transfer to the sonotrode is reduced. Ultrasonic sonotrodes often have a textured contact surface (i.e., knurl) that permits some additional deformation and gripping of the welding materials. This knurl can be quite aggressive and is dependent on the hardness and thickness of the materials to be joined. The hybrid process of this invention demonstrates that by reducing the yield strength of the material, a sonotrode geometry that more closely resembles that of a resistance spot welding electrode can be used. The resistance spot weld style tip can adequately grip the material leaving behind only shallow indentation. Material sticking is also reduced by the disclosed systems and methods.

The experimental data presented herein also demonstrates that increasing the applied current promotes sonotrode displacement into the material, therefore generating a larger weld. However, the applied ultrasonic power does not have the same effect when used in conjunction with resistive heating. Higher ultrasonic power does not necessarily yield larger or stronger welds. This non-linear behavior could be the result of power limits of the welder, the continuous bonding and breaking of the joint during the welding process, or the inability to reach the necessary powers when operated at high pressures. Often the high pressures needed for thicker materials causes overloading of the welder due to lack of available power for the transducers. Operating in the hybrid mode of this invention helps to alleviate these power requirements of the welder by reducing the yield strength of the material and allowing the sonotrodes to displace the material more easily. This process in turn lowers the overall energy in both applied current and ultrasonic power needed to weld.

The highest resistance welding current applied in the experiments described herein was 10 kA which is markedly lower than a typical welding current for aluminum (approximately 30 kA typical). Infrastructure in an automotive assembly plant can easily apply 10 kA welding current, whereas a 30 kA or greater welding current may require significant modifications to the plant's electrical systems. Metallurgically, the welds lack apparent pores. Porosity is common in resistance spot weld as previously described and can be attributed to significant strength loss in aluminum joints. However, with the hybrid process of this invention, these welds are predominately solid state thus reducing risk of increased porosity. This is therefore a gain in joint efficiency and constancy.

In summary, the present invention provides a welding system that combines ultrasonic spot-welding technology with resistance heat welding technology. As previously described, ultrasonic spot-welding methods can be limited by the amount of power (e.g., 10-kW) that can be delivered to the sonotrode. The addition of resistance heating to an ultrasonic weld can reduce the yield strength and enable ultrasonic metal welds to be produced in higher-strength materials. Thermal assistance permits a reduction in shear loads predominantly by pre-plasticizing the metal (e.g., aluminum). By reducing energy required to deform a part and increasing the effective welding zone, the ability to spot weld thicker, higher-strength materials at lower power requirements is achievable, potentially simplifying ultrasonic spot-welding equipment requirements and extending applications. A Sonobond dual wedge reed (DWR) ultrasonic welder and Miyachi resistance welder (RW) were used together to create hybrid welds on aluminum 6061. Round sonotrode tips were used for the DWR and custom current carrying clamps were used with the RW to pass current through lap joint configured aluminum coupons. Custom clamps were chosen rather than attaching electrodes to the sonotrode tips. The sonotrode tips were made of tool steel because it is conductive, able to withstand high wear from the transverse ultrasonic motion and transmits ultrasound with low scatter. Round sonotrode tips were used to weld aluminum rather than the knurled tips often used for thicker sheets of material. This invention is not limited to a specific ultrasonic welder. It may be possible to configure any available ultrasonic welder to operate in hybrid mode by either modifying the sonotrode to carry current or apply current separately through the parts as long as sonotrode pressure is engaged.

The following references form part of this disclosure and are incorporated herein by reference in their entirety for all purposes: (1) J. Gould, “Joining Aluminum Sheet in the Automotive Industry—A 30 Year History,” Welding Journal, 91, (2012), 23-34; (2) D. J. Spinella, J. R. Brockenbrough, J. M. Fridy, “Trends in aluminum resistance spot welding for the auto industry”, American Welding Society, 84. No. 1 (2005); (3) Warwick Manufacturing Group, “Developments towards high-volume resistance spot welding of aluminum automotive sheet component”, International Automotive Research Centre. https://warwick.ac.uk/fac/sciwmgiresearch/pard/projects/advbodyjoin/results/rsw (accessed Jul. 30, 2018); (4) T. C. Balder, “Influence of the Peltier effect in resistance welding,” Phillips Technical Review, Volume 20, PP 188-192; (5) D. R. Boomer, J. A. Hunter, D. R. Castle, “A new approach for robust high-productivity resistance spot welding of aluminum,” SAE Transactions 112 (2003), 280-292; (6) The Technology Utilization Office, National Aeronautics and Space Administration, Contract NASW-2022, Application of Aerospace Technology in Industry, A Technology Transfer Program for Welding, Technology Management Group, Abt Associates Inc., Cambridge, Mass., September 1971; (7) Reversing DC and the Benefits of Joining Lightweight Materials, Nov. 28, 2016, Roman Manufacturing; (8) K. Graff, “A History of Ultrasonics,” Physical Acoustics, 15 (1981), 1-97; (9) T. Kanda, K. Kimua, S. Nisino, “A study on the application of ultrasonic vibration to direct spot welding of aluminum alloy (part 1),” 35, No. 10 (1966) 59-66; (10) M. D. Bhandarkar, W. B. Lisagor, “Metallurgical characterization of the fracture of several high strength aluminum alloys,” NASA Technical Paper 1086 (1977); (11) X. Sun, Resistance spot weld failure mode and weld performance for aluminum alloys, Failure Mechanisms of Advanced Welding Processes, (2010), 24-42; and (12) M. Kimchi, D. H. Phillips, Resistance Spot Welding: Fundamentals and Applications for the Automotive Industry, Morgan & Claypool Publishers (2017).

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, described techniques, or the like, this application controls.

As used herein, the singular forms “a,” “an,” and “the,” refer to both the singular as well as plural, unless the context clearly indicates otherwise. The term “comprising” as used herein is synonymous with “including,” “containing.” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about” used throughout this specification are used to describe and account for small fluctuations, such as due to variations in processing. For example, they can refer to less than or equal to ±5%, such as less than or equal to ±0.2%, such as less than or equal to ±1%, such as less than or equal to ±0.5%, such as less than or equal to ±0.2%, such as less than or equal to ±0.1%, such as less than or equal to ±0.05%, and/or 0%.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

What is claimed:

1. A hybrid welding system, comprising:
(a) a first welding system, wherein the first welding system includes an ultrasonic spot-welding system, and wherein the ultrasonic spot-welding system further includes at least one sonotrode for delivering ultrasonic vibration to a predetermined weld location; and
(b) a second welding system, wherein the second welding system includes a resistance spot welding system that functions simultaneously with the ultrasonic spot-welding system, and wherein the resistance spot welding system further includes at least one electrode that is configured to direct electrical current into the predetermined weld location.

2. The system of claim 1, further comprising cooper and steel clamps, wherein the copper and steel clamps cooperate with the resistance spot welding system to direct electrical current into parts to be welded together at a predetermined weld location.

3. The system of claim 1, further comprising at least one ultrasonic transducer connected to the at least one sonotrode for delivering power thereto.

4. The system of claim 1, further comprising a first material to be welded and a second material to be welded to the first material.

5. The system of claim 4, wherein the first and second materials are the same material.

6. The system of claim 5, wherein the first and second materials are aluminum.

7. The system of claim 4, wherein the first and second materials are the different materials.

8. The system of claim 7, wherein the first material is aluminum and the second material is stainless steel.

9. The system of claim 1, wherein the electrical current is 10 kA or less.

10. The system of claim 1, wherein the sonotrode further comprises a reed sonotrode.

11. The system of claim 1, wherein the sonotrode includes a rounded tip for delivering ultrasonic vibration to the predetermined weld location.

12. A hybrid welding system, comprising:
(a) a first material;
(b) a second material to be spot welded to the first material at a predetermined location;
(c) an ultrasonic spot-welding system, wherein the ultrasonic spot-welding system further comprises at least one sonotrode having a rounded tip for delivering ultrasonic vibration to a predetermined weld location; and
(d) a resistance spot welding system that functions simultaneously with the ultrasonic spot-welding system, wherein the resistance spot welding system further includes at least one electrode that is configured to pass electrical current through the predetermined weld location.

13. The system of claim 12, further comprising cooper and steel clamps, wherein the copper and steel clamps cooperate with the resistance spot welding system to direct electrical current into parts to be welded together at a predetermined weld location.

14. The system of claim 12, further comprising at least one ultrasonic transducer connected to the at least one sonotrode for delivering power thereto.

15. The system of claim 12, wherein the first and second materials are aluminum.

16. The system of claim 12, wherein the first material is aluminum and the second material is stainless steel.

17. The system of claim 12, wherein the electrical current is 10 kA or less.

18. A welding system, comprising:
(a) a first material;
(b) a second material to be spot welded to the first material at a predetermined location;
(c) an ultrasonic spot-welding system, wherein the ultrasonic spot-welding system further comprises at least one sonotrode having a rounded tip for delivering ultrasonic vibration to the predetermined location and at least one transducer connected to the at least one sonotrode; and
(d) a resistance spot welding system, wherein the resistance spot welding system is operative to function simultaneously with the ultrasonic spot-welding system, and wherein the resistance spot welding system further includes at least one electrode that is configured to pass electrical current through the predetermined location, wherein the electrical current is 10 kA or less.

19. The system of claim 18, further comprising cooper and steel clamps, wherein the copper and steel clamps cooperate with the resistance spot welding system to direct electrical current into parts to be welded together at a predetermined weld location.

20. The system of claim 18, wherein the first and second materials are aluminum or wherein the first material is aluminum and the second material is stainless steel.
